(19) United States
(12) Patent Application Publication
(10) Pub. No.: US 2023/0271558 A1
(43) Pub. Date: Aug. 31, 2023

(54) RETRACTABLE STEPS FOR A VEHICLE

(71) Applicants: Ningbo Geely Automobile Research & Development Co., Ltd., Ningbo (CN); Zhejiang Geely Holding Group Co., Ltd., Zhejiang (CN)

(72) Inventors: Magnus NILSSON, Floda (SE); Erik LINDBERG NILSSON, Göteborg (SE)

(21) Appl. No.: 18/308,601

(22) Filed: Apr. 27, 2023

Related U.S. Application Data
(63) Continuation of application No. PCT/CN2021/129094, filed on Nov. 5, 2021.

(30) Foreign Application Priority Data
Nov. 10, 2020 (EP) 20206788.0

(51) Int. Cl. B60R 3/02

(52) U.S. Cl. CPC B60R 3/02

(57) ABSTRACT

A system for a vehicle having a vehicle body, a vehicle door and at least one retractable step, wherein the vehicle body encloses a passenger compartment and defines a vehicle door opening and wherein the vehicle door is moveable relative to the vehicle door opening between a closed position and an open position. The system has at least one retractable step being connected to the vehicle door and to the vehicle body, and wherein the at least one connected retractable step is extendable by movement of the vehicle door in a direction from the closed position towards the open position. The at least one retractable step includes a flexible member configured for extending between the vehicle door and the vehicle body.

### RELATED APPLICATION DATA

This application is a continuation of International Patent Application No. PCT/CN2021/129094, filed Nov. 5, 2021, which claims the benefit of European Patent Application No. 20206788.0, filed Nov. 10, 2020, the disclosures of which are incorporated herein by reference in their entireties.

### TECHNICAL FIELD

The present disclosure relates generally to the field of retractable steps. More particularly, it relates to retractable steps for a vehicle.

### BACKGROUND

Typically, children are small and have short legs which means that it is not easy for them to enter or exit a vehicle without assistance.

Since children are surprisingly heavy, providing assistance to them when entering or exiting a vehicle may be a burden or pose a risk of injury for the person providing the assistance.

Considering that children like to do things themselves, entering or exiting the vehicle without assistance may pose a risk for the child such as putting their feet in unintentional places or being at risk of falling etc.

Therefore, there is a need for alternative approaches for providing assistance when entering or exiting a vehicle.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a system for a vehicle.

The vehicle comprising a vehicle body, a vehicle door and at least one retractable step, wherein the vehicle body encloses a passenger compartment and defines a vehicle door opening and wherein the vehicle door is moveable relative to the vehicle door opening between a closed position and an open position.

The system is characterized in that the at least one retractable step is configured for being connected to the vehicle door and to the vehicle body, and wherein the at least one retractable step is extendable by movement of the vehicle door in a direction from the closed position towards the open position. The at least one retractable step comprises a flexible member configured for extending between the vehicle door and the vehicle body.

An advantage of some embodiments is that alternative approaches for providing assistance when entering or exiting a vehicle are provided.

An advantage of some embodiments is that the at least one retractable step is automatically deployed when entering or exiting a vehicle.

An advantage of some embodiments is that small children are assisted in entering or exiting the vehicle.

An advantage of some embodiments is that a burden or risk of injury for the person providing assistance when entering or exiting the vehicle is either eliminated or reduced.

An advantage of some embodiments is that a risk for the child to put their feet in unintentional places or being at risk of falling, etc., is reduced.

An advantage of some embodiments is that the at least one retractable step is reliably deployed.

An advantage of some embodiments is that the flexible member is a retractable component which when retracted may be folded away and when extended may provide climbing support for entering or exiting the vehicle.

In some embodiments, the at least one retractable step is retractable by movement of the vehicle door in a direction from the open position towards the closed position.

An advantage of some embodiments is that the at least one retractable step is automatically retracted by a closing movement of the vehicle door.

An advantage of some embodiments is that the at least one retractable step is reliably retracted.

In some embodiments, the at least one retractable step is connected to the vehicle door and a vehicle structure enclosed in the vehicle body and/or in the passenger compartment.

An advantage of some embodiments is that the at least one retractable step may be fully integrated in the vehicle avoiding a bulky external component which may cause collisions with objects under the vehicle when deployed or be affected in its function by weather, e.g., snow, ice, etc.

In some embodiments, the vehicle door comprises a detent mechanism configured for controlling a required force to close the vehicle door connected with the at least one retractable step when being in the open position.

An advantage of some embodiments is that a detent feel is provided by the detent mechanism when closing the vehicle door.

In some embodiments, the vehicle door comprises a locking arrangement configured for arranging the at least one connected retractable step in locking engagement to the vehicle door.

An advantage of some embodiments is that the at least one retractable step when connected to the vehicle door is secured by the locking arrangement to avoid the at least one retractable step to mistakenly be retracted.

In some embodiments, the locking arrangement comprises an electronically controlled plunger arranged to lock at least one latch of the at least one retractable step protruded into the vehicle door.

An advantage of some embodiments is that the electronically controlled plunger may automatically lock the at least one latch.

An advantage of some embodiments is that the electronically controlled plunger may be remotely controlled to lock the at least one latch.

In some embodiments, the flexible member is arranged as a belt configured for extending between the vehicle door and the vehicle body. The belt is providing a simple and reliable construction of the retractable step. The belt is arranged as a retractable component which when retracted may be folded away and when extended may provide climbing support for entering or exiting the vehicle.

In some embodiments, the system further comprises a roller configured for rolling up the belt into a retracted state when the vehicle door is in the closed position and rolling out the belt into an extended state when the vehicle door is in the open position. The roller is used for an efficient rolling up operation of the belt when extended into the retracted state.

In some embodiments, the roller is pivotally connected to the body of the vehicle, allowing a pivoting movement of the roller in relation to the body of the vehicle when extending and retracting the retractable step during opening or closing of the vehicle door. The pivotal connection of the roller is allowing a pivoting movement around a pivoting axis during opening and closing of the vehicle door. The pivoting movement of the roller is allowing an angular displacement during displacement of the vehicle door when extending and retracting the retractable step.

In some embodiments, the flexible member is arranged as a wire structure configured for extending between the vehicle door and the vehicle body. The retractable step comprises a plurality of rigid step elements attached to a wire structure. The combination of the wire structure and the rigid step elements is providing an alternative simple and reliable construction of the retractable step. The wire structure with the rigid step elements is arranged as a retractable component which when retracted may be folded away and when extended may provide climbing support for entering or exiting a vehicle.

In some embodiments, the system further comprises a storage container configured for storing the retractable step in a retracted state. The retractable step is configured for being extended from the storage container into an extended state when opening the vehicle door. The container is efficiently storing the wire structure and the rigid step elements when the retractable step is in the retracted state.

In some embodiments, the at least one retractable step forms a climbing step for climbing in and/or out of the passenger compartment.

An advantage of some embodiments is that the climbing step provides assistance for entering or exiting a vehicle.

In some embodiments, the system is enabled by a user through settings in the vehicle or by activating a child lock on the vehicle door.

An advantage of some embodiments is that user control of the system is enabled.

A second aspect is a vehicle comprising the system according to the first aspect.

A third aspect is a method for a vehicle.

The vehicle comprising a vehicle body, a vehicle door and at least one retractable step, wherein the vehicle body encloses a passenger compartment and defines a vehicle door opening and wherein the vehicle door is moveable relative to the vehicle door opening between a closed position and an open position. The at least one retractable step is configured for being connected to the vehicle door and to the vehicle body, and the at least one retractable step comprises a flexible member configured for extending between the vehicle door and the vehicle body.

The method comprising activating a connection of the at least one retractable step to the vehicle door and to the vehicle body, extending the at least one connected retractable step by movement of the vehicle door in a direction from the closed position towards the open position.

An advantage of some embodiments is that alternative approaches for providing assistance when entering or exiting a vehicle are provided.

An advantage of some embodiments is that the at least one retractable step is automatically deployed when entering or exiting a vehicle.

An advantage of some embodiments is that small children are assisted in entering or exiting the vehicle.

An advantage of some embodiments is that a burden or risk of injury for the person providing assistance when entering or exiting the vehicle is either eliminated or reduced.

An advantage of some embodiments is that a risk for the child to put their feet in unintentional places or being at risk of falling, etc., is reduced.

An advantage of some embodiments is that the at least one retractable steps is reliably deployed.

In some embodiments, the method further comprises retracting the at least one connected retractable step by movement of the vehicle door in a direction from the open position towards the closed position.

An advantage of some embodiments is that the at least one retractable step is automatically retracted by a closing movement of the vehicle door.

An advantage of some embodiments is that the at least one retractable step is reliably retracted.

In some embodiments, the at least one retractable step is connected to the vehicle door and a vehicle structure enclosed in the vehicle body and/or in the passenger compartment.

An advantage of some embodiments is that the at least one retractable step may be fully integrated in the vehicle avoiding a bulky external component which may cause collisions with objects under the vehicle when deployed or be affected in its function by weather, e.g., snow, ice, etc.

An advantage of some embodiments is that an external ladder or stool is no longer needed for providing assistance when entering or exiting a vehicle, especially considering that an external ladder or stool takes up much space in the trunk of a vehicle.

An advantage of some embodiments is that the retractable step is less sensitive to uneven terrain compared to an external ladder or stool that would be hard to place without tumbling it over.

In some embodiments, the method further comprises controlling a required force to close the vehicle door when being in the open position by a detent mechanism comprised in the vehicle door.

An advantage of some embodiments is that a detent feel is provided by the detent mechanism when closing the vehicle door.

In some embodiments, the method further comprises locking the at least one connected retractable step to the vehicle door by a locking arrangement comprised in the vehicle door.

An advantage of some embodiments is that the at least one retractable step when connected to the vehicle door is secured by the locking arrangement to avoid the at least one retractable step to mistakenly be retracted.

In some embodiments, the locking arrangement comprises an electronically controlled plunger arranged to lock at least one latch of the at least one retractable step protruded into the vehicle door.

An advantage of some embodiments is that the electronically controlled plunger may automatically lock the at least one latch.

An advantage of some embodiments is that the electronically controlled plunger may be remotely controlled to lock the at least one latch.

A fourth aspect may include a computer program product comprising a non-transitory computer readable medium, having thereon a computer program comprising program instructions. The computer program is loadable into a data processing unit and configured to cause execution of the method according to the third aspect when the computer program is run by the data processing unit.

Any of the above aspects may additionally have features identical with or corresponding to any of the various features as explained above for any of the other aspects.

It should be noted that, even if embodiments are described herein in the context of retractable steps for a vehicle, some embodiments may be equally applicable and/or beneficial also in other contexts wherein retractable steps are provided.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIGS. 1A-1B are schematic drawings illustrating example systems according to some embodiments;

FIGS. 2A-2B are schematic drawings illustrating example connections according to some embodiments;

FIGS. 2C-2E are schematic drawings illustrating example components according to some embodiments;

FIGS. 3A-3C are schematic drawings illustrating example components according to some embodiments;

FIGS. 4A-4B are schematic drawings illustrating example components according to some embodiments;

FIG. 5 is a flowchart illustrating example method steps according to some embodiments;

FIG. 6 is a schematic block diagram illustrating an example apparatus according to some embodiments; and

FIG. 7 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be presented where alternative approaches for providing assistance when entering or exiting a vehicle are described.

Retractable steps, as described herein, typically comprise steps configured to be extended, i.e., deployed, and retracted, i.e., withdrawn, wherein the retractable steps in the extended state are deployed to form climbing steps for providing assistance when climbing in and/or out of a vehicle, and in the retracted state are withdrawn and integrated in the vehicle.

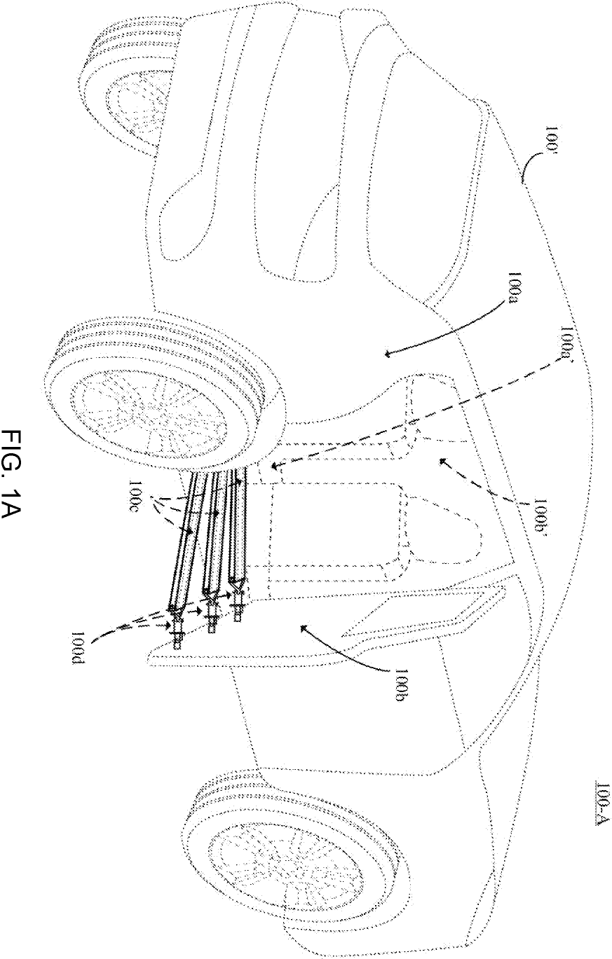

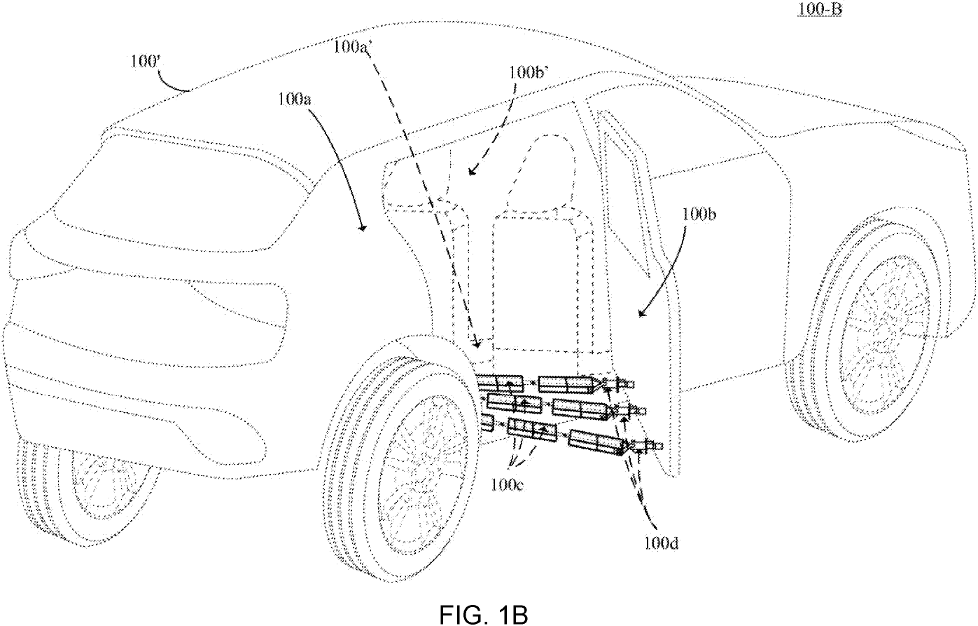

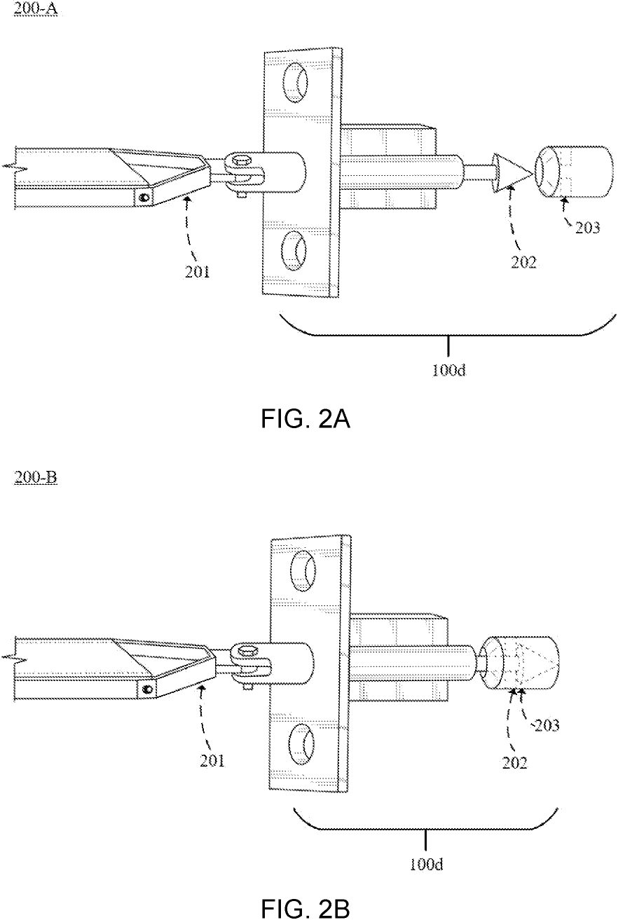

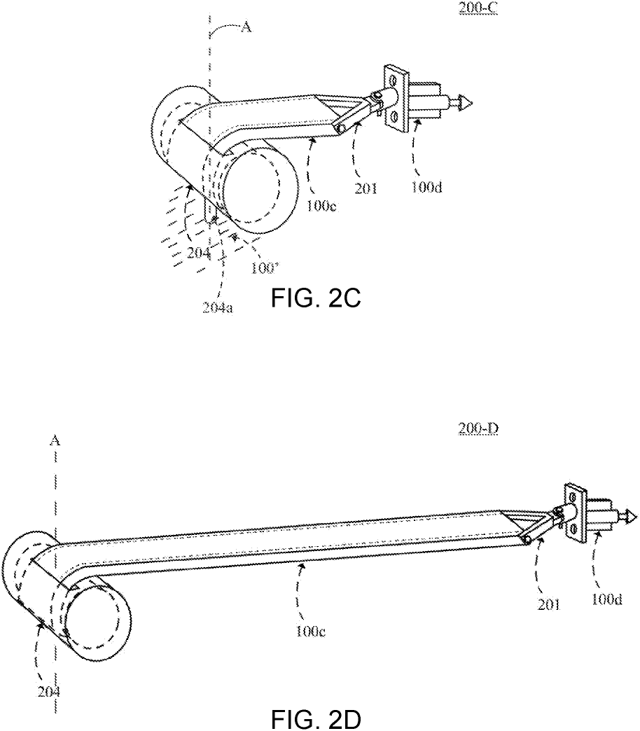

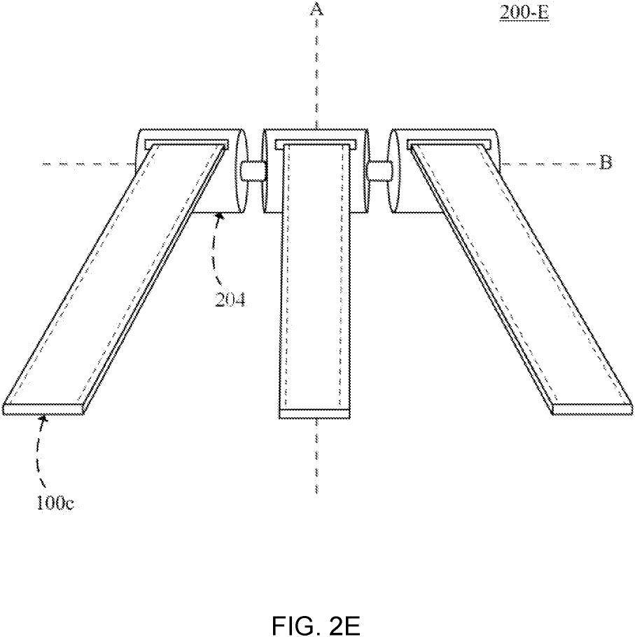

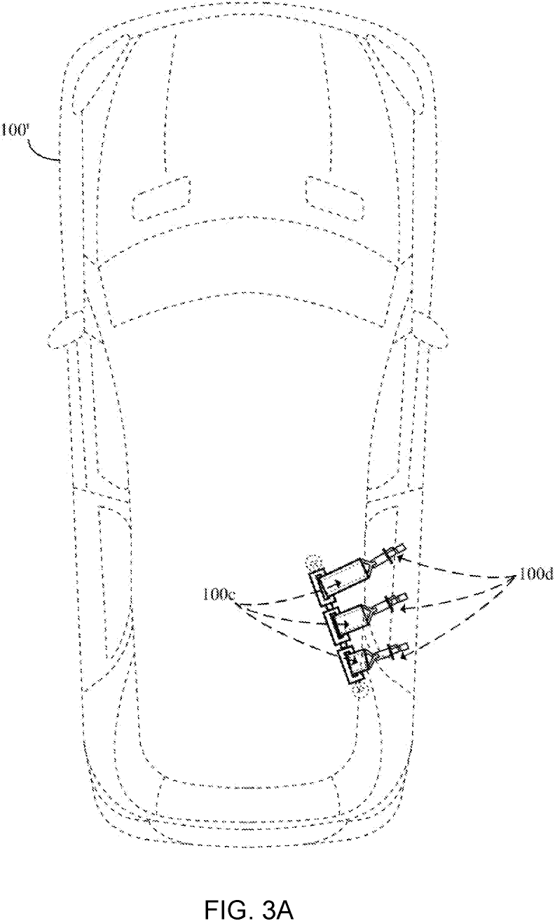

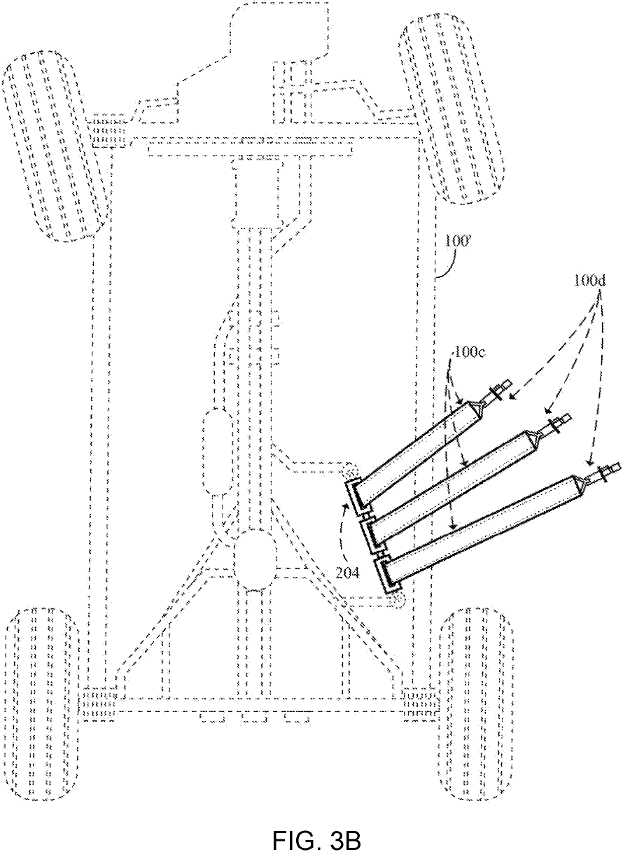

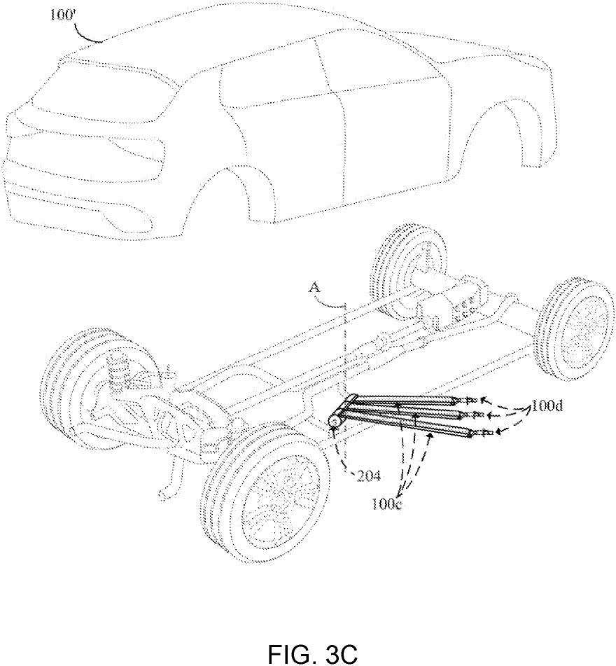

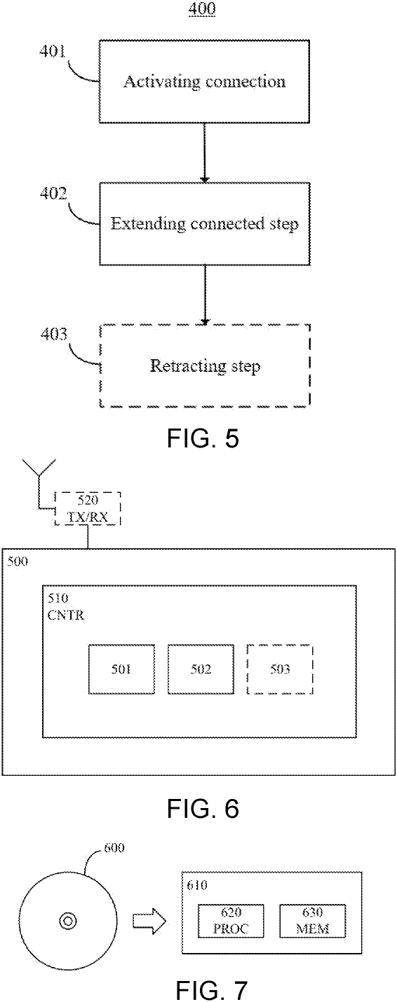

FIGS. 1A-1B are schematic drawings illustrating components (further illustrated in FIGS. 2A-2E and FIGS. 3A-3C) of example systems 100-A, 100-B according to some embodiments. The systems 100-A, 100-B are for a vehicle. Thus, the systems 100-A, 100-B may, for example, comprise the components of FIGS. 2A-2E and FIGS. 3A-3C and/or the apparatus 500 and/or the controller 510 of FIG. 6 and be configured to perform one or more of the method steps of FIG. 5 and/or one or more of any steps otherwise described herein; all of which will be described later herein.

FIGS. 1A-1B illustrate the systems 100-A, 100-B for a vehicle 100′ as well as components further illustrated in FIGS. 2A-2E and FIGS. 3A-3C.

FIGS. 1A-1B further illustrate the vehicle 100′ comprising a vehicle body 100a, a vehicle door 100b in an open position, and three retractable steps 100c (illustrated as flexible members in the form of a flexible belt structure in FIG. 1A, and flexible members in the form of a flexible belt, wire or chain structure comprising plates or solid plates arranged in connection to each other in FIG. 1B) in an extended state connected to the vehicle door 100b and the vehicle body 100a.

The vehicle body 100a encloses a passenger compartment and defines a vehicle door opening 100b′, wherein the vehicle door 100b is moveable relative to the vehicle door opening 100b′ between a closed position and an open position.

The retractable steps 100c are connected to the vehicle door 100b and to the vehicle body 100a and are extendable by movement of the vehicle door 100b in a direction from the closed position towards the open position.

For example, when opening the vehicle door 100b from the closed position, assuming that the retractable steps are connected to the vehicle door 100b, the retractable steps 100c are extended by the opening (i.e. opening movement) of the vehicle door 100b.

Optionally, in some embodiments, the connected retractable steps 100c are retractable by movement of the vehicle door 100b in a direction from an open position towards the closed position.

For example, when closing the vehicle door 100b from an open position, assuming that the retractable steps are connected to the vehicle door 100b, the retractable steps 100c are retracted by the closing (i.e., closing movement) of the vehicle door 100b.

Alternatively, in some embodiments, the connected retractable steps 100c may be retracted by firstly releasing the connection of the retractable steps 100c to the vehicle door 100b by a release mechanism, and secondly urging the retractable steps 100c, e.g. by a spring function or manually, to its retracted state, i.e. to its rest position. The releasing of the connection of the retractable steps 100c to the vehicle door 100b and/or the urging of the retractable steps 100c to its rest position may be triggered by a user control, e.g., a user may control the retractable steps 100c accordingly through a release/retract function in the Human Machine Interface (HMI) of the vehicle 100′, in a key fob, or in an app.

Alternatively or additionally, the opening and/or the closing movements of the vehicle door 100b may be controlled remotely by a suitable control device and possibly be opened/closed automatically, and thereby the retractable steps 100c may also be extended/retracted automatically by the remotely controlled movement of the vehicle door 100b assuming that the retractable steps 100c are connected to the vehicle door 100b.

In some embodiments, the retractable steps 100c are connected to the vehicle door 100b and a vehicle structure 100a′ enclosed in the vehicle body 100a and/or in the passenger compartment.

In some embodiments, the vehicle structure 100a′ comprises a seat and/or a structural body part of the vehicle 100′.

For example, the retractable steps 100c may be connected to the vehicle door 100b and a seat in the passenger compartment of the vehicle 100′.

For example, the retractable steps 100c may be connected to the vehicle door 100b and a part of the body, e.g. a body on a pillar or on side sills, of the vehicle 100′.

Alternatively or additionally, a first one of the retractable steps 100c may be connected to the vehicle door 100b and a seat, a second one of the retractable steps 100c may be connected to the vehicle door 100b and body of a pillar of the vehicle 100′, and a third one of the retractable steps 100c may be connected to the vehicle door 100b and body of side sills of the vehicle 100′.

In some embodiments, the retractable steps 100c comprise one or more of the flexible members, such as belts (as illustrated in FIG. 1A), and flexible members comprising solid plates (as illustrated in FIG. 1B). Instead of belts, flexible members such as chains or wires may alternatively be used.

For all embodiments, the term flexible member is encompassing any suitable structure having flexible non-rigid material properties, such as belts, wires or chains. The flexible member can suitably be bent, folded, or rolled-up for simple storage when retracted and not used. Further, rigid structures, such as plates or similar arrangements may be attached to the flexible member to form the retractable steps. The flexible members may be made of any suitable material, such as for example woven belt structures, metal wires and chains. Other suitable materials for the flexible members may be composite materials, polymeric materials or fabrics.

For example, the retractable steps 100c may comprise wires, wherein each of the retractable steps 100c may comprise a plurality of wire structures forming the step.

For example, the retractable steps 100c may comprise belts, wherein each belt may be rolled up on a roller in a vehicle structure 100a′, e.g., body of the vehicle, when retracted (reference to FIGS. 2C and 3A).

For example, as understood from FIG. 1B, the retractable steps 100c may comprise solid plates attached to flexible members such as belts, chains or wires. The plates may be arranged in a way and hard enough to hold the vehicle door 100b open in the extended state, while when in the retracted state, the plates may be slid into and/or under a vehicle structure 100a′, e.g. a seat.

In some embodiments, the retractable steps 100c form climbing steps for climbing in and/or out of the passenger compartment (as illustrated in FIGS. 1A-1B and FIGS. 3B-3C).

In some embodiments, the retractable steps 100c may comprise one or more climbing steps depending on the height of the vehicle 100′.

In some embodiments, the vehicle door 100b comprises a detent mechanism for controlling a required force to close the vehicle door 100b connected with the retractable steps 100c when being in the open position.

For example, the detent mechanism holding the vehicle door 100b open may be configured to be controllably hard so that the vehicle door 100b will take more force to close when the retractable steps 100c are deployed.

In some embodiments, the systems 100-A, 100-B are enabled by a user of the vehicle 100′.

For example, the user may activate the systems 100-A, 100-B through settings in the HMI, or in an app, or by setting the child lock active on the vehicle door 100b.

For example, when the user activates the systems 100-A, 100-B, a plunger will descend and connect (as illustrated in FIGS. 2A-2B) the retractable steps 100c to the vehicle door 100b and when the user opens the vehicle door 100b, the retractable steps 100c will extend by the opening movement in a space between the vehicle door 100b and the vehicle body 100a.

Hence, when the systems 100-A, 100-B are not activated and the retractable steps are not connected to the vehicle door 100b, the retractable steps 100c will remain in the vehicle body 100a′ in its retracted state as the door opens, i.e., in its rest position (as illustrated in FIG. 3A).

In some embodiments, a vehicle 100′ comprises the system 100-A or 100-B.

FIGS. 2A-2B are schematic drawings illustrating an example connection according to some embodiments. More specifically, FIG. 2A illustrates a connection arrangement 200-A in an unlocked state and FIG. 2B illustrates a connection arrangement 200-B in a locked state for connecting and locking the retractable step 100c to the vehicle door 100b.

The connection arrangement 200-A, 200-B comprises, in some embodiments, a locking arrangement 100d for locking the retractable step 100c to the vehicle door 100b, wherein the retractable step 100c is connected to the locking arrangement 100d with a pivot connection 201.

In some embodiments, the locking arrangement 100d comprises an electronically controlled plunger 202 arranged to be protruded into a latch housing 203.

For example, when the vehicle door 100b is in a closed position and at activation of the systems 100-A, 100-B, the plunger 202 is protruded into the latch housing 203 and locked (as illustrated in FIGS. 2A-2B) so that the retractable step 100c is connected and locked to the vehicle door 100b.

Alternatively or additionally, the locking arrangement 100d may lock the retractable step when the vehicle door 100b is in an open position by manually extending (e.g., by a user of the systems 100-A, 100-B) the retractable step 100c to connect and be locked with the vehicle door 100b via the locking arrangement 100d.

FIG. 2C is a schematic drawing illustrating an example component 200-C according to some embodiments. More specifically, FIG. 2C illustrates a retractable step 100c comprising a belt in a retracted state, wherein the retractable step 100c is configured to be connected to a locking arrangement 100d with a locking mechanism (not shown) via a pivot connection 201 (reference to FIGS. 2A-2B) . The pivot connection 201 is allowing an angular displacement of the example component 200-C during displacement of the vehicle door 100b for extending or retracting the retractable step 100c.

FIG. 2C further illustrates a roller 204 suitable for rolling up or maintaining the belt 100c in a retracted state when the vehicle door 100b is in the closed position or when the belt is in a rest position when not connected to the locking arrangement 100d and the vehicle door 100b.

FIG. 2D is a schematic drawing illustrating an example component 200-D according to some embodiments. More specifically, FIG. 2D illustrates a retractable step 100c comprising a belt in an extended state, wherein the retractable step 100c is configured to be connected to a locking arrangement 100d with a locking mechanism (not shown) via a pivot connection 201 (reference to FIGS. 2A-2B). The pivot connection 201 is allowing an angular displacement of the example component 200-D during displacement of the vehicle door 100b for extending or retracting the retractable step 100c.

FIG. 2D further illustrates a roller 204 suitable for rolling out the belt 100c when connected to the locking arrangement 100d and the vehicle door 100b.

The roller 204 is thus configured for rolling up the belt into the retracted state when the vehicle door 100b is in the closed position, as shown in FIG. 2C, and rolling out the belt into the extended state, as shown in FIG. 2D, when the vehicle door 100b is in the open position.

FIGS. 2C-2D further illustrates that the roller 204 suitably is pivotally connected to the body of the vehicle 100′, allowing a pivoting movement of the roller 204 in relation to the body when extending and retracting the retractable step 100c during opening or closing of the vehicle door 100b. As schematically illustrated in FIG. 2C, the roller 204 is connected to the body of the vehicle 100′ via a pivoting element 204a, such as a hinge structure, a pivoting shaft, or similar arrangement. The pivoting element 204a may in an alternatively non-illustrated embodiment be connected to a frame structure to which the roller 204 is connected. In this way, the roller 204 can pivot around a pivoting axis A during opening and closing of the vehicle door 100b. The pivoting movement of the roller 204 is allowing an angular displacement of the example component 200-C, 200-D during displacement of the vehicle door 100b when extending and retracting the retractable step 100c. Two or more rollers 204 may be connected to each other and arranged to pivot around a common pivoting axis, or alternatively each roller 204 is pivotally connected to the body of the vehicle 100′. A similar pivoting solution may also be used for the other embodiments described.

FIG. 2E is a schematic drawing illustrating an example component 200-E according to some embodiments. More specifically, FIG. 2E illustrates retractable steps 100c comprising belts in an extended state, wherein the rollers 204 have rolled out the belts 100c.

FIG. 2E further illustrates each roller 204 as pivotable rollers being arranged so that the belts 100c may be rolled out and up perpendicular to a roller axis B of the rollers 204 when the vehicle door 100b is opened and closed. The roller assembly illustrated in FIG. 2E may further be arranged to pivot around a pivoting axis A in relation to the body of the vehicle 100′, in a similar way as described above in connection to FIG. 2C.

FIG. 3A is a schematic drawing illustrating example components according to some embodiments. More specifically, FIG. 3A illustrates the retractable steps 100c being embedded in the vehicle body 100a′ in its retracted state, i.e., in its rest position.

FIG. 3A further illustrates the locking arrangements 100d being embedded in the vehicle door 100b.

FIGS. 3B-3C are schematic drawings illustrating example components according to some embodiments. More specifically, FIGS. 3B-3C illustrate, from different views, the rollers 204 being embedded in the vehicle body 100a′ and the retractable steps 100c in its extended state, wherein the retractable steps 100c are connected and locked to the locking arrangements 100d being embedded in the vehicle door 100b. As schematically shown in FIG. 3C, the rollers 204 are suitably pivotally arranged in relation to the body of the vehicle 100′, and are with this configuration allowed to pivot around a common pivoting axis A, in a similar way as described in connection to FIG. 2C.

FIGS. 3B-3C further illustrate the extended retractable steps 100c forming climbing steps as described above.

FIGS. 3B-3C furthermore illustrate the retractable steps 100c as belts, wherein each belt may be rolled up on the roller 204 (reference to FIG. 2D) in the vehicle structure 100a′, e.g., body of the vehicle, when retracted.

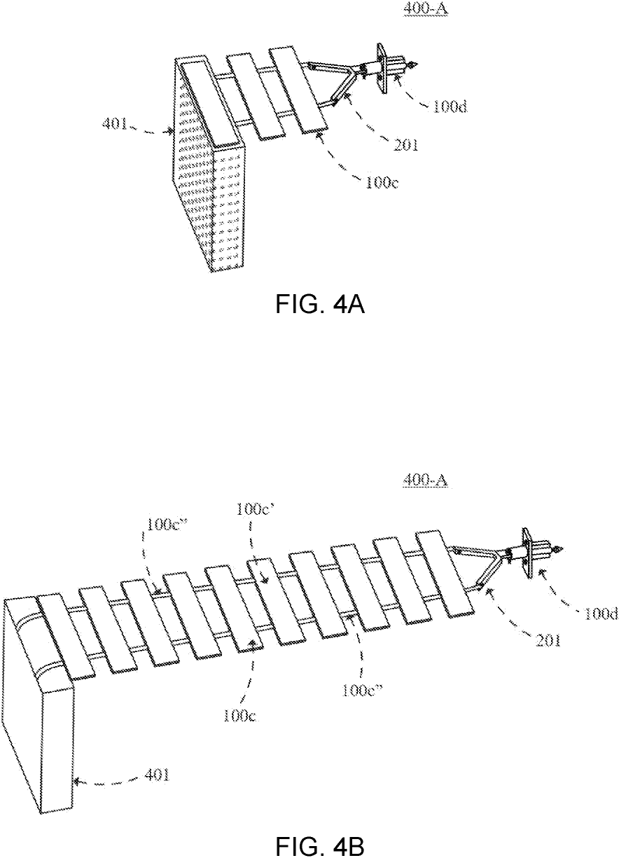

FIGS. 4A-4B are schematic drawings illustrating an example system 400-A according to some embodiments. The system 400-A may, for example, comprise the apparatus 500 and/or the controller 510 of FIG. 6 and be configured to perform one or more of the method steps of FIG. 5 and/or one or more of any steps otherwise described herein. The system 400-A is arranged in a vehicle 100′, as described above. In this embodiment, the flexible member is arranged as a wire structure 100c″ configured for extending between the vehicle door 100b and the vehicle body 110a. More specifically, FIGS. 4A-4B illustrate a retractable step 100c comprising a plurality of rigid step elements 100c′ attached to the wire structure 100c″. In this embodiment, the retractable step 100c is having a blind-like configuration that is easily extended and retracted, and the step elements 100c′ are arranged after each other on the wire structure 100c″. Each step element 100c′ is suitably arranged as a solid plate with an elongated configuration, as shown in FIGS. 4A-4B. In the retraced state shown in FIG. 4A, the retractable step 100c is stored in a storage container 401, from which the retractable step 100c can be extended from the retracted state when opening the vehicle door 100b. The extended state is schematically shown in FIG. 4B. The storage container 401 is suitably connected to the body of the vehicle 100′. With this arrangement, the system further comprises the storage container 401 configured for storing the retractable step 100c in the retracted state, and the retractable step 100c is configured for being extended from the storage container 401 into the extended state when opening the vehicle door 100b. The retractable step 100c may for example be connected to a non-illustrated spring arrangement or similar device for stacking or piling up the step elements 100c′ on top of each other in the storage container 401, as shown in FIG. 4A, when closing the vehicle door 100b. In a similar way as described above in connection to FIG. 2C, the retractable step 100c is configured to be connected to a locking arrangement 100d with a locking mechanism (not shown) via a pivot connection 201. The storage container 401 is suitable for maintaining the belt 100c in a rest position when not connected to the locking arrangement 100d and the vehicle door 100b. The storage container 401 may further be arranged with a stopping mechanism or similar device that is preventing further extension of the retractable step 100c when the vehicle door 100b is held in a non-fully open door position, for a safe functionality of the retractable step 100c.

FIG. 5 is a flowchart illustrating method steps of an example method 400 according to some embodiments. The method 400 is for a vehicle. Thus, the method 400 may, for example, in the system 100-A of FIG. 1A and/or in the system 100-B of FIG. 1B and be performed by components of FIGS. 2A-2E, 3A-3C, 4A-4B, and/or the apparatus 500 and/or the controller 510 of FIG. 6; all of which will be described later herein.

The vehicle for which method 400 is suitable for may be the vehicle 100′, as illustrated in the system 100-A of FIG. 1A and 100-B of FIG. 1B.

The vehicle 100′ comprising a vehicle body 100a, a vehicle door 100b, and retractable steps 100c, wherein the vehicle body 100a encloses a passenger compartment and defines a vehicle door opening 100b′, and wherein the vehicle door 100b is moveable relative to the vehicle door opening 100b′ between a closed position and an open position.

The method 400 comprises the following steps.

In step 401, a connection of the at least one retractable step to the vehicle door and to the vehicle body is activated.

In some embodiments, the at least one retractable step is connected to the vehicle door and a vehicle structure enclosed in the vehicle body and/or in the passenger compartment.

In some embodiments, the at least one connected retractable step is locked to the vehicle door by a locking arrangement comprised in the vehicle door.

In some embodiments, the locking arrangement comprises an electronically controlled plunger arranged to lock at least one latch of the at least one retractable step protruded into the vehicle door.

In step 402, the at least one connected retractable step is extended by movement of the vehicle door in a direction from the closed position towards the open position.

In optional step 403, in some embodiments, the at least one connected retractable step is retracted by movement of the vehicle door in a direction from the open position towards the closed position.

In some embodiments, a required force is controlled to close the vehicle door when being in the open position by a detent mechanism comprised in the vehicle door.

Alternatively, in some embodiments, the at least one retractable step may be retracted by a release mechanism releasing the connection of the at least one retractable step to the vehicle door, and a retraction mechanism, e.g., a spring function, urging the at least one retractable step to its retracted state, i.e., to its rest position. The release mechanism and retraction mechanism may be controlled by a user, e.g., a user may control the at least one retractable step accordingly through a release/retract function in the Human Machine Interface (HMI), or in an app.

Alternatively or additionally, the opening and/or the closing movements of the vehicle door may be controlled remotely and possibly be opened/closed automatically, and thereby the at least one retractable step may also be extended/retracted automatically by the remotely controlled movement of the vehicle door assuming that the at least one retractable step is connected to the vehicle door.

In the different embodiments described, the step elements 100c′ are made of a suitable material or combinations of suitable materials, such as for example plastic materials, reinforced plastic materials, composite materials, solid wood, wood laminates, aluminium, and other metals or metallic materials.

FIG. 6 is a schematic block diagram illustrating an example apparatus 500 according to some embodiments. The apparatus 500 is for a vehicle. Thus, the apparatus 500 and/or the controller 510 may, for example, be configured to perform one or more of the method steps of FIG. 5 and/or one or more of any steps otherwise described herein in the systems 100-A of FIG. 1A, 100-B of FIG. 1B, and/or 400-A of FIGS. 4A-4B.

The vehicle for which apparatus 500 is suitable for may be the vehicle 100′, as illustrated in the systems 100-A of FIG. 1A, and/or 100-B of FIG. 1B.

The vehicle 100′ comprising a vehicle body 100a, a vehicle door 100b, and retractable steps 100c, wherein the vehicle body 100a encloses a passenger compartment and defines a vehicle door opening 100b′, and wherein the vehicle door 100b is moveable relative to the vehicle door opening 100b′ between a closed position and an open position.

The apparatus 500 comprises a controller 510, e.g. device controlling circuitry, configured to cause activation of a connection of the at least one retractable step to the vehicle door and to the vehicle body.

The controller 510 is further configured to cause extension of the at least one connected retractable step by remotely controlling movement of the vehicle door in a direction from the closed position towards the open position.

Optionally, in some embodiments, the controller 510 is furthermore configured to cause retraction of the at least one connected retractable step by remotely controlling movement of the vehicle door in a direction from the open position towards the closed position.

The apparatus 500 comprises, as mentioned above, the controller (CNTR; e.g., control circuitry or a controlling module) 510, which may in turn comprise, (or be otherwise associated with; e.g., connected or connectable to), a system activator 501, e.g. system activating circuitry or system activating module, configured to activate a system and a connection of the at least one retractable step to the vehicle door and to the vehicle body (compare with step 401 of FIG. 5).

In some embodiments, the at least one retractable step is connected to the vehicle door and a vehicle structure enclosed in the vehicle body and/or in the passenger compartment.

In some embodiments, the at least one connected retractable step is locked to the vehicle door by a locking arrangement comprised in the vehicle door.

In some embodiments, the locking arrangement comprises an electronically controlled plunger arranged to lock at least one latch of the at least one retractable step protruded into the vehicle door.

The controller 510 further comprises, (or is otherwise associated with; e.g., connected or connectable to), a door opener 502, e.g. door opening circuitry or door opening module, configured to remotely open a vehicle door causing extension of the at least one connected retractable step (compare with step 402 of FIG. 5).

Optionally, in some embodiments, the controller 510 may further comprise, (or be otherwise associated with; e.g., connected or connectable to), a door closer 503, e.g. door closing circuitry or door closing module, configured to remotely close a vehicle door causing retraction of the at least one connected retractable step (compare with step 403 of FIG. 5).

In some embodiments, a required force is controlled to close the vehicle door when being in the open position by a detent mechanism comprised in the vehicle door.

In some embodiments, the apparatus 500 and/or the controller 510 is comprised completely or partially in the vehicle and/or remotely in a cloud environment.

In some embodiments, the apparatus 500 and/or the controller 510 is operably connectable to controlling circuitry in a vehicle and/or in a cloud environment.

The apparatus 500 may further optionally comprise, (or be otherwise associated with; e.g., connected or connectable to), in some embodiments, a transceiver TX/RX 520, e.g. transceiving circuitry or transceiving module, configured to transmit and receive radio signals, e.g., in accordance with remotely controlling a vehicle.

Generally, when an apparatus is referred to herein, it is to be understood as a physical product. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), Graphics Processing Units (GPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

FIG. 7 illustrates an example computer readable medium in the form of a compact disc (CD) ROM 600. The computer readable medium has stored thereon a computer program comprising program instructions. The computer program is loadable into a data processor (PROC) 620, which may, for example, be comprised in a wireless communication device 610. When loaded into the data processor, the computer program may be stored in a memory (MEM) 630 associated with or comprised in the data processor.

In some embodiments, the computer program may, when loaded into and run by the data processing unit, cause execution of steps according to, for example, FIG. 5 and/or one or more of any steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

What is claimed is:

1. A system for a vehicle comprising a vehicle body, a vehicle door and at least one retractable step, wherein the vehicle body encloses a passenger compartment and defines a vehicle door opening and wherein the vehicle door is moveable relative to the vehicle door opening between a closed position and an open position, wherein:
the at least one retractable step is configured for being connected to the vehicle door and to the vehicle body,
wherein the at least one retractable step is extendable by movement of the vehicle door in a direction from the closed position towards the open position, and
wherein the at least one retractable step comprises a flexible member configured for extending between the vehicle door and the vehicle body.

2. The system according to claim 1, wherein the at least one retractable step is retractable by movement of the vehicle door in a direction from the open position towards the closed position.

3. The system according to claim 1, wherein the at least one retractable step is connected to the vehicle door and a vehicle structure enclosed in the vehicle body and/or in the passenger compartment.

4. The system according to claim 1, wherein the vehicle door comprises a detent mechanism configured for controlling a required force to close the vehicle door connected with the at least one retractable step when being in the open position.

5. The system according to claim 1, wherein the vehicle door comprises a locking arrangement configured for arranging the at least one connected retractable step in locking engagement to the vehicle door.

6. The system according to claim 5, wherein the locking arrangement comprises an electronically controlled plunger arranged to lock at least one latch of the at least one retractable step protruded into the vehicle door.

7. The system according to claim 1, wherein the flexible member is arranged as a belt configured for extending between the vehicle door and the vehicle body.

8. The system according to claim 7, wherein the system further comprises a roller configured for rolling up the belt into a retracted state when the vehicle door is in the closed position and rolling out the belt into an extended state when the vehicle door is in the open position.

9. The system according to claim 8, wherein the roller is pivotally connected to the body of the vehicle, allowing a pivoting movement of the roller in relation to the body of the vehicle when extending and retracting the retractable step during opening or closing of the vehicle door.

10. The system according to claim 1, wherein the flexible member is arranged as a wire structure configured for extending between the vehicle door and the vehicle body, wherein the retractable step comprises a plurality of rigid step elements attached to a wire structure.

11. The system according to claim 10, wherein the system further comprises a storage container configured for storing the retractable step in a retracted state, wherein the retractable step is configured for being extended from the storage container into an extended state when opening the vehicle door.

12. The system according to claim 1, wherein the at least one retractable step forms a climbing step for climbing in and/or out of the passenger compartment.

13. The system according to claim 1, wherein the system is enabled by a user through settings in the vehicle or by activating a child lock on the vehicle door.

14. A vehicle comprising the system according to claim 1.

15. A method for a vehicle comprising a vehicle body, a vehicle door and at least one retractable step, wherein the vehicle body encloses a passenger compartment and defines a vehicle door opening and wherein the vehicle door is moveable relative to the vehicle door opening between a closed position and an open position, wherein the at least one retractable step is configured for being connected to the vehicle door and to the vehicle body, and wherein the at least one retractable step comprises a flexible member configured for extending between the vehicle door and the vehicle body, the method comprising:
activating a connection of the at least one retractable step to the vehicle door and to the vehicle body,
extending the at least one connected retractable step by movement of the vehicle door in a direction from the closed position towards the open position.

16. The method according to claim 15, further comprising the step of:
retracting the at least one connected retractable step by movement of the vehicle door in a direction from the open position towards the closed position.

17. The method according to claim 15, wherein the at least one retractable step is connected to the vehicle door and a vehicle structure enclosed in the vehicle body and/or in the passenger compartment.

18. The method according to claim 15, further comprising controlling a required force to close the vehicle door when being in the open position by a detent mechanism comprised in the vehicle door.

19. The method according to claim 15, further comprising locking the at least one connected retractable step to the vehicle door by a locking arrangement comprised in the vehicle door.

20. The method according to claim 19, wherein the locking arrangement comprises an electronically controlled plunger arranged to lock at least one latch of the at least one retractable step protruded into the vehicle door.
